(19) United States
(12) Patent Application Publication
(10) Pub. No.: US 2017/0153703 A1
(43) Pub. Date: Jun. 1, 2017

(54) PIEZOELECTRIC HAPTIC FEEDBACK STRUCTURE

(71) Applicant: Microsoft Technology Licensing, LLC, Redmond, WA (US)

(72) Inventors: Gahn Yun, Seattle, WA (US); Carl Picciotto, Clyde Hill, WA (US); Sheila A. Longo, Seattle, WA (US); Aric Ahkeel Fitz-Coy, Seattle, WA (US); Rahul Marwah, Seattle, WA (US); John Jacob Nelson, Redmond, WA (US)

(21) Appl. No.: 14/954,281

(22) Filed: Nov. 30, 2015

(51) Int. Cl. G06F 3/01; G06F 3/041; G06F 3/0354

(52) U.S. Cl. CPC G06F 3/016; G06F 3/03547; G06F 3/041; G06F 2203/04105

(57) ABSTRACT

A piezoelectric haptic feedback structure disclosed herein includes a supporting base defining a cavity and a piezoelectric actuator assembly at least partially suspended within the cavity. A perimeter hinge secures a perimeter portion of the piezoelectric actuator assembly while permitting movement of a central portion of a piezoelectric actuator. The piezoelectric actuator haptic feedback structure further includes a force-communicating structure that communicates haptic feedback responsive to movement of the central portion of the piezoelectric actuator assembly within the cavity.

### BRIEF DESCRIPTIONS OF THE DRAWINGS

FIG. 1 illustrates an example computing device with a haptic feedback touchpad including a piezoelectric haptic feedback structure.

FIG. 2 illustrates an exploded view of a haptic feedback touchpad including a piezoelectric haptic feedback structure with a number of upper layers and a base assembly.

FIG. 3 illustrates components of another example piezoelectric haptic feedback structure.

FIG. 4 illustrates perspective and cross-sectional views of yet another example piezoelectric haptic feedback structure.

FIG. 5 illustrates a cross-sectional view of another example piezoelectric haptic feedback structure.

FIG. 6 illustrates cross-sectional views of a piezoelectric haptic feedback structure during different stages of use.

FIG. 7A illustrates a cross-sectional view of another example piezoelectric haptic feedback structure.

FIG. 7B illustrates a top-down view of the example piezoelectric haptic feedback structure of FIG. 7A.

FIG. 8A illustrates a cross-sectional view of another example piezoelectric haptic feedback structure.

FIG. 8B illustrates a top-down view of the example piezoelectric haptic feedback structure of FIG. 8A.

FIG. 9 illustrates a top-top view of another example piezoelectric haptic feedback structure.

FIG. 10 illustrates example operations for using a piezoelectric haptic feedback structure to provide haptic feedback.

### DETAILED DESCRIPTIONS

A conventional trackpad includes a touchpad plate hinged above a dome switch. The plate is typically hinged from the top edge. Consequently, the response of the trackpad is not uniform and the upper region is difficult to “click.” These conventional trackpads also struggle to reject inadvertent actuations when a user is typing, thereby causing a cursor to jump around in a random manner and interfere with a user's interaction with a computing device, which is both inefficient and frustrating.

Haptic feedback and/or pressure sensing techniques can be utilized in place of the traditional dome/hinge structure to provide for a more even touch response. In one implementation of the disclosed technology, an input device such as a trackpad, key of a keyboard, and so forth, is configured to support haptic feedback and/or pressure sensing. For example, piezoelectric actuators may be arranged at the corners of a trackpad and used to suspend the trackpad. When pressure is detected on a touch surface (e.g., a user pressing a surface of the trackpad with a finger), the piezoelectric actuators are energized to provide haptic feedback that may be felt by the user. In some implementations, piezoelectric actuators are also usable to detect a “touch pressure” (e.g., of the user's finger), such as by monitoring output voltage of the piezoelectric actuators generated due to strain caused by the pressure transferred to the piezoelectric actuators.

Implementations disclosed herein provide a piezoelectric haptic feedback structure including features that provide a secure grip on the perimeter of a piezoelectric actuator while permitting the piezoelectric actuator to flex across a range of motion, contributing to a uniformity of feel and pressure sensing across the surface of a touchpad.

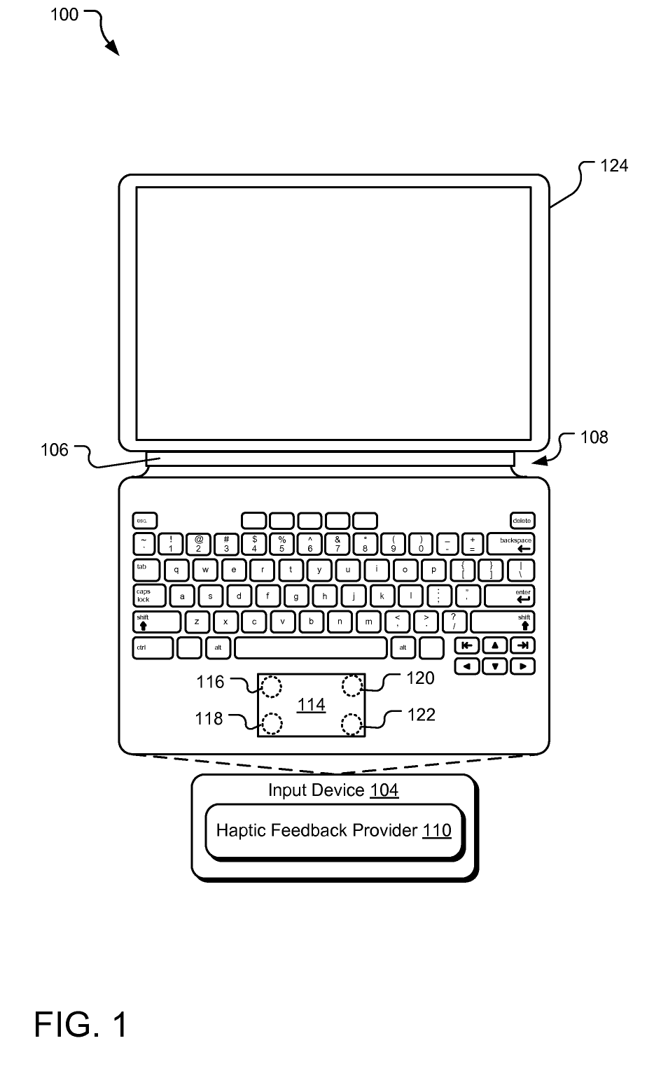

FIG. 1 illustrates an example computing device 100 with a haptic feedback touchpad 114 (e.g., a trackpad) including a piezoelectric haptic feedback structure. The computing device 100 includes a display 124, computing electronics (not shown), and an input device 104. The computing device 100 may be configured in a variety of ways, such as for mobile use (e.g., a watch, mobile phone, a tablet computer as illustrated, and so on). Thus, the computing device 100 may range from full resource devices with substantial memory and processor resources to a low-resource device with limited memory and/or processing resources.

Electronics of the computing device 100 include memory storing a haptic feedback provider 110 and a processor for executing instructions of the haptic feedback provider 110. In various implementations, the haptic feedback provider 110 may be embodied as hardware and/or software stored in a tangible computer readable storage media. As used herein, tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can accessed by mobile device or computer. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal.

The haptic feedback provider 110 is shown as part of the input device 104, but may be stored anywhere within or communicatively coupled to the computing device 100. A connection portion 108 of the computing device 100 provides a communicative and physical connection between the input device 104 and a processor (not shown) of the computing device 100. The connection portion 108 is flexibly connected by a flexible hinge 106 to a portion of the input device 104 that includes keys. In various implementations, the input device 104 may be physically attached to the computing device 100 (e.g., as shown), or may be physically separated from the computing device 100. For example, the input device 104 may wirelessly couple to the computing device 100.

Haptic feedback mechanisms 116, 118, 120, and 122 are disposed at respective corners to suspend an outer surface of the haptic feedback touchpad 114 and to provide haptic feedback to a user. According to one implementation, each of the haptic feedback mechanisms 116, 118, 120, and 122 includes a piezoelectric actuator and one or more other supporting layers or structures, such as a force-transferring structure to precisely focus and transfer force to and/or from the underlying piezoelectric actuator(s). In FIG. 1, the entirety of the weight of a touch surface of the haptic feedback touchpad 114 is borne by four total piezoelectric actuators, one in each of the haptic feedback mechanisms 116, 118, 120, and 122. The piezoelectric actuators are situated underneath the touch surface, thereby allowing the topside of the touch surface to be available for additional sensing systems.

As discussed in detail with respect to the following figures, each of the haptic feedback mechanisms 116, 118, 120, and 122 includes a support structure that acts as a hinge to allow the associated piezoelectric actuators to flex in one or more directions. According to one implementation, flexing of one or more of the piezoelectric actuators generates a signal that translates to haptic feedback at a surface that can be felt by a user.

Although shown to be a trackpad, the haptic feedback touchpad 114 may take on a variety of forms. For example, the haptic feedback touchpad 114 may be a screen or touchable component of any electronic device (e.g., a display or other outer casing of a tablet, watch, phone, fitness tracker, etc.). In some implementations, the haptic feedback touchpad provides haptic feedback based at least in part on sensed amounts of pressure. For example, a trackpad may provide a physical sensation (e.g., pop, vibration, etc.) to a user responsive to detection of a user's attempt to “click” the trackpad. In other implementations, the haptic feedback touchpad 114 may not receive any user input. For example, the haptic feedback touchpad 114 may vibrate a casing of a smart watch responsive to certain events (e.g., message alerts, pre-set notifications, etc.).

In other implementations, the haptic feedback touchpad 114 provides haptic feedback responsive to pressure detection and/or a measured amount of pressure that the user applies to the haptic feedback touchpad 114. For example, a light amount of applied pressure results in a first instance of haptic feedback (e.g., a single click), while an increased amount of applied pressure results in a second, isolated instance of haptic feedback (e.g., a double click). Instances of haptic feedback may vary in magnitude and effect. In one implementation, the haptic feedback provider 110 receives the output signal from the haptic feedback touchpad 114 and controls movement of a cursor on the display 124 based on the signal.

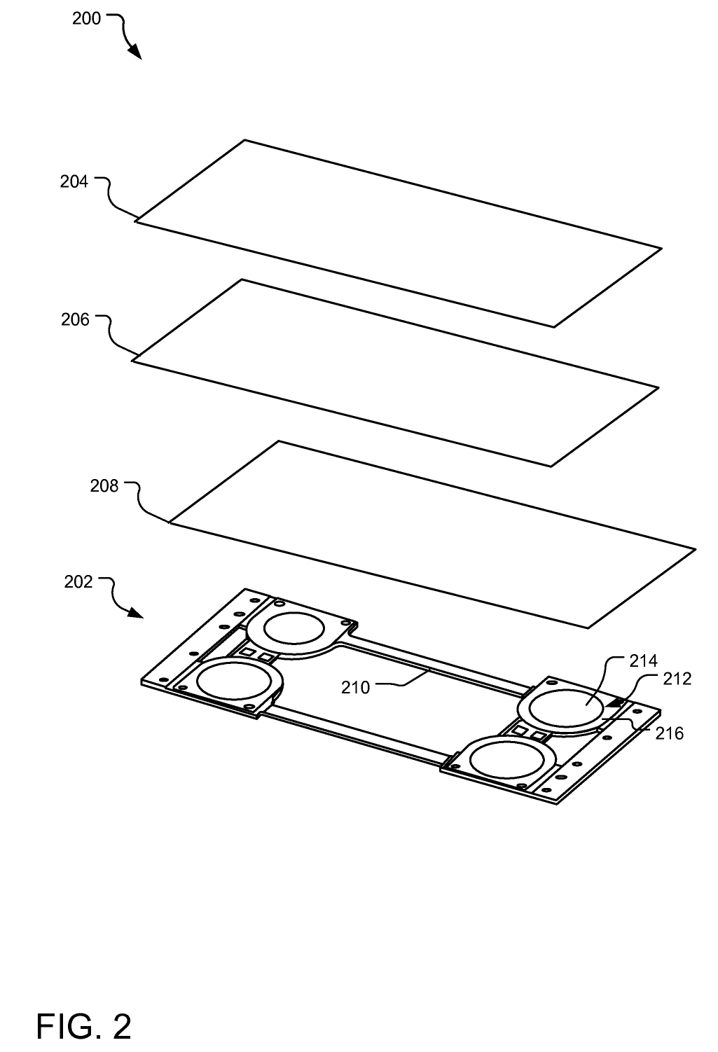

FIG. 2 illustrates an exploded view of a piezoelectric haptic feedback structure 200. The piezoelectric haptic feedback structure 200 includes a base assembly 202 in addition to a number of upper layers (e.g., a touch surface 204, a pressure-sensitive adhesion layer 206, and a printed circuit board assembly (PCBA) 208). In one implementation, the touch surface 204 is a made of a slick, hard material. For example, the touch surface 204 may be crystal silk, glass, or a variety of other suitable materials. In one implementation, the touch surface 204 is a glass bead-filled material on a polyethylene terephthalate (PET) substrate. The pressure-sensitive adhesion layer 206 adheres a front side of the PCBA 208 to the touch surface 204 and a back side of the PCBA 208 is further adhered to the base assembly 202 by additional adhesive (not shown).

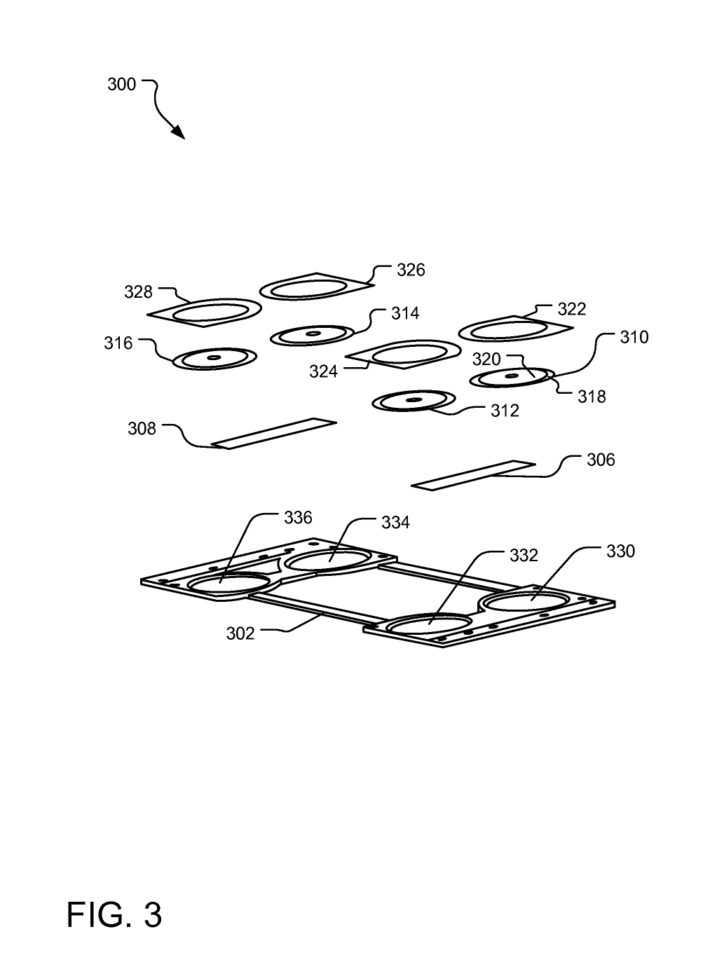

The base assembly 202 of the piezoelectric haptic feedback structure 200 includes a base 210 with a cavity formed proximal to each of four corners (e.g., corner cavities also referred to as “buckets” are shown in greater detail with respect to FIG. 3). Piezoelectric actuator assemblies (e.g., a piezoelectric actuator assembly 214) are positioned within each of the four corner cavities of the base assembly 202. A perimeter hinge (e.g., circular hinge 212) allows a center portion of each piezoelectric actuator assembly to flex in response to pressure applied to the touch surface 204.

As used herein a “perimeter hinge” refers to a joint or a plurality of joints that secure a perimeter of a flexible element (e.g., a piezoelectric actuator assembly) in a stationary position while facilitating unidirectional or bidirectional movement of a central portion of the flexible element about the joint or plurality of joints. A circular hinge is an example perimeter hinge formed about a circular perimeter. Example perimeter hinges described herein are generally circular, but may assume different shapes in different implementations depending on the type of piezoelectric actuator(s) employed in each implementation.

In one implementation, the circular hinge 212 is a two-way hinge that permits flexing of the piezoelectric actuator assembly 214 toward a base of the corresponding cavity in the base assembly 202. The circular hinge 212 may facilitate movement of a center of the piezoelectric actuator assembly 214 downward into the cavity response to pressure (e.g., user contact) as well as upward in response to electrical vibrations generated by the piezoelectric actuator assembly 214.

In FIG. 2, the circular hinge 212 is a two-way hinge formed by an annular retention plate 216 that acts as a top clamp securing the underlying piezoelectric actuator assembly 214 into the corresponding corner bucket of the base 210. In one implementation, the annular retention plate 216 is flexible. For example, the annular retention plate 216 may be formed from mylar, glass-reinforced epoxy laminate sheets (e.g., FR4), plastic, or a variety of other suitable elastic materials. Example implementations including a flexible annular retention plate are discussed in greater detail below with respect to FIGS. 3-6.

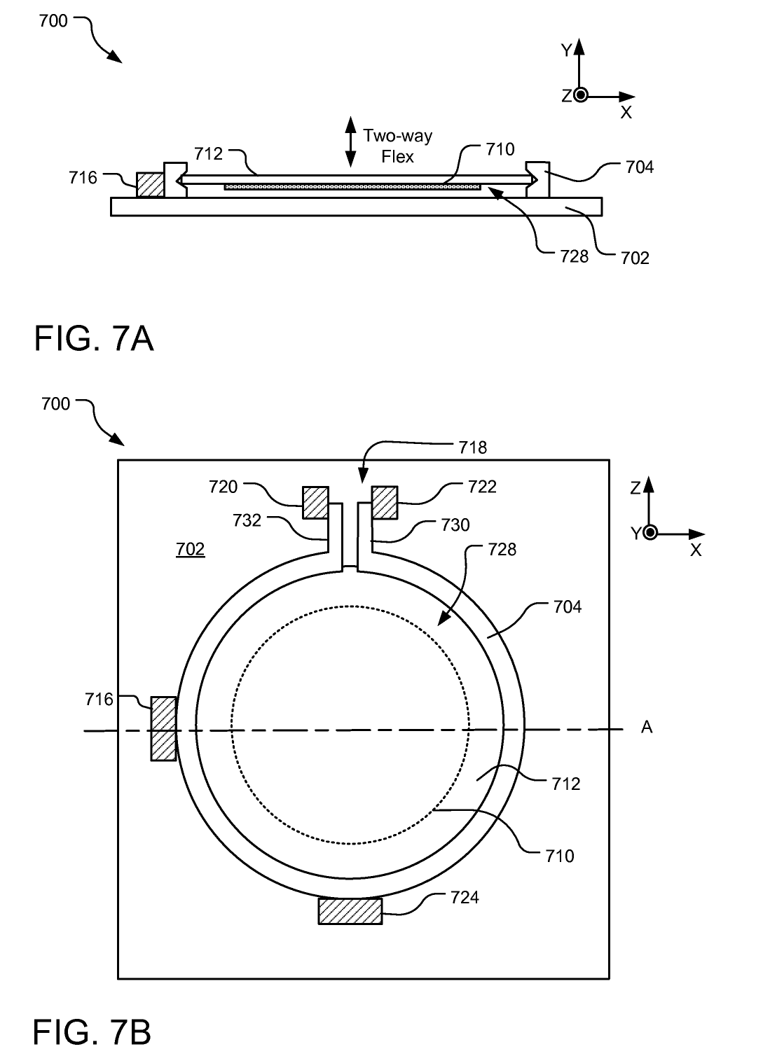

In another implementation, the circular hinge 212 is a two-way hinge formed by a v-grooved rigid support ring. An example implementation including a v-grooved rigid support ring is discussed in greater detail with respect to FIGS. 7A-7B.

FIG. 3 illustrates components of another example piezoelectric haptic feedback structure 300. The piezoelectric haptic feedback structure 300 includes, among other components, a base 302 including four corner buckets 330, 332, 334, and 336 formed proximal to each of four corners of the base 302. Two flexible printed circuits (FPCs) 306 and 308 are each configured to extend between and rest within two corresponding buckets in the base 302. The FPCs 306 and 308 provide electrical leads to complete connections between a PCBA (not shown) and four piezoelectric actuator assemblies 310, 312, 314, or 316. Each of the piezoelectric assemblies 310, 312, 314, and 316 is sized and shaped for positioning within one of the corresponding buckets of the base 302.

Each of the piezoelectric actuator assemblies 310, 312, 314, and 316 includes a thin metal support (e.g., a thin metal support 318) with a lower surface attached to a piezoelectric actuator (not shown). A force-communicating structure (e.g., force-communicating structure 320) is formed on the thin metal support of each of the piezoelectric actuator assemblies 310, 312, 314, and 316. This force-communicating structure 320 may, for example, aid in transferring force initially distributed across a wide area to a smaller area on the associated piezoelectric actuator assembly. As used herein, the term “force-communicating structure” may refer to an internal component of a piezoelectric actuator haptic feedback structure (e.g., such as the force-communicating structure 320), but may also be used to refer to an external component of a piezoelectric actuator haptic feedback structure (e.g., a touch surface).

In one implementation, the FPCs 306 and 308 each include springs (not shown) for completing an electrical connection to a lower surface of the piezoelectric actuator assemblies 310, 312, 314, and 316. These springs can be compressed during assembly and configured to move up and down with the piezoelectric actuator assemblies during use. The springs can further help to support and prevent overstressing of each of the piezoelectric actuator assemblies 310, 312, 314, and 316.

The piezoelectric haptic feedback structure 300 further includes four annular retention plates 322, 324, 326, and 328 that are each configured to secure a perimeter portion of a corresponding one of the piezoelectric actuator assemblies 310, 312, 314, and 316 against a rim of a corresponding bucket in the base 302. If the annular retention plates 322, 324, 326, and 328 are constructed from a flexible material, the annular retention plates each move a little with the underlying piezoelectric actuator assemblies, like a diaphragm, effectively acting as a two-way circular hinge. In some implementations, the piezoelectric haptic feedback structure 300 includes additional elements formed on top of the force-communicating structure 320 of each of the piezoelectric actuator assemblies 310, 312, 314, and 316. For example, the piezoelectric actuator assemblies 310, 312, 314, and 316 may be coated with adhesive for attachment to a PCBA (not shown) and one or more stiffening elements may be included to help absorb and transfer vibrations.

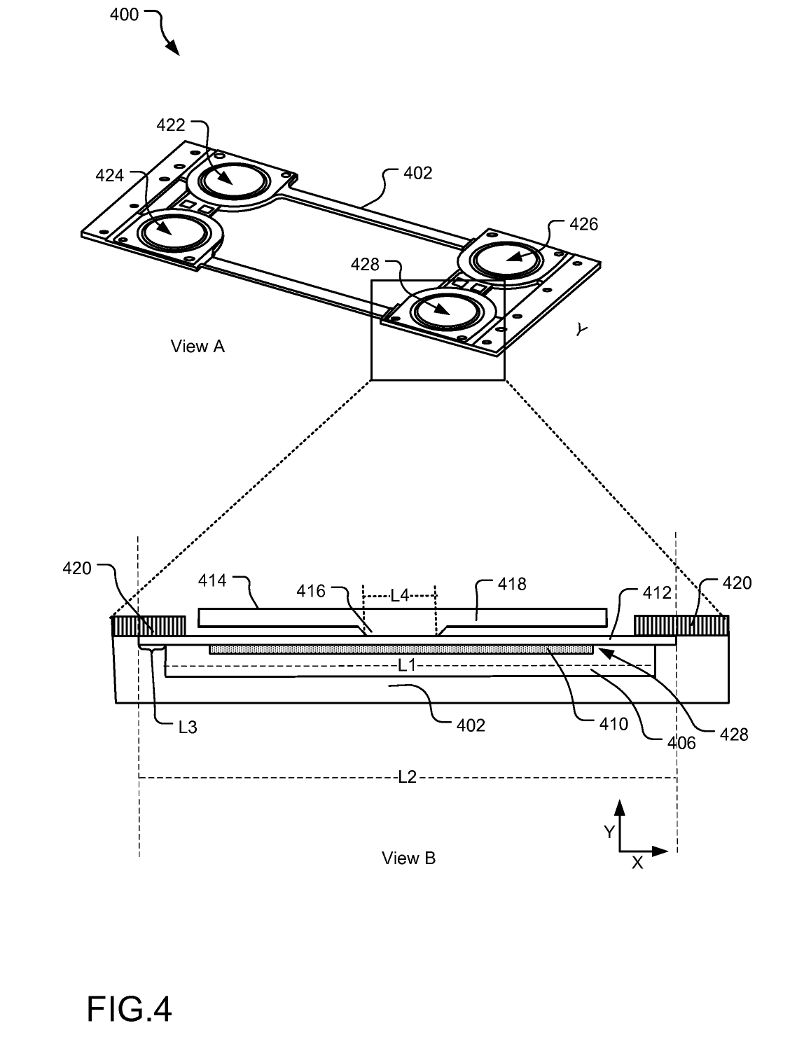

FIG. 4 illustrates views of another example piezoelectric haptic feedback structure 400. View A shows a perspective view including four piezoelectric actuator assemblies 422, 424, 426, and 428 each positioned within a corner bucket formed in a base 402 of the piezoelectric haptic feedback structure 400. Providing more detail, View B illustrates the piezoelectric actuator assembly 428 suspended within a cavity 406 and held in place by an annular retention plate 420. The piezoelectric actuator assembly 428 includes a piezoelectric actuator 410 and a thin metal support 412. In one example implementation, the thin metal support 412 is 20 mm in diameter and the piezoelectric actuator 410 is a ceramic disk 15 mm in diameter. The piezoelectric actuator can be made from a variety of suitable piezo ceramic materials including without limitation PZT, electroactive polymer, or electromechanical polymer.

A force-communicating structure 414 (e.g., a “high hat” structure) is formed on top of the piezoelectric actuator assembly 428. The force-communicating structure 414 includes a narrow base portion (e.g., a dimple 416 contacting the thin metal support 412) and a wider upper neck portion 418. The force-communicating structure 414 facilitates a redistribution of a contact force initially distributed across a large area (e.g., the wide neck upper portion 418) to a much smaller area (e.g., a center of the piezoelectric actuator assembly 428).

A perimeter portion of the thin metal support 412 rests within an upper tier portion of the cavity 406, while the piezoelectric actuator 410 is suspended within a lower tier portion of the cavity 406. The lower tier portion of the cavity 406 has a diameter L1 that is less than a corresponding diameter L2 of the upper tier portion of the cavity 406. The upper tier of the cavity 406 is formed deep enough to ensure that the thin metal support 412 is seated on a flat surface of the cavity 406 and is flush with the surface. In contrast, the lower tier of the cavity 406 with the diameter L1 is deep enough to allow enough room for an FPC with a spring contact (not shown) to fit beneath the piezoelectric actuator 410. A spring contact may, for example, extend upward from the base of the cavity 406 and through the piezoelectric actuator assembly 428 to establish an electrical connection with the piezoelectric actuator 410 and one or more upper layers (not shown) in the piezoelectric haptic feedback structure 400.

In one implementation, an FPC (not shown) in the lower tier of the cavity 406 acts as a stop to prevent over-stressing the piezoelectric actuator assembly 428. The added height of the spring contact and FPC in the center of the cavity 406 support the piezoelectric actuator assembly 428 during downward movement, providing a counter force that helps to prevent the piezoelectric actuator assembly 428 from contacting a base of the cavity 406.

The annular retention plate 420 rests against and contacts a top rim of the bucket portion of the base 402. In one implementation, the annular retention plate 420 is made of an elastic material that flexes slightly when pressure is applied to the thin metal support 412, providing a diaphragm-like effect. Consequently, a center portion of the piezoelectric actuator assembly 428 is permitted to flex bidirectionally, both toward and away from a base of the cavity 406.

An overlap length L3 represents a difference in the diameters L2 and L1 (e.g., L2-L1) and determines, in part, how much of the thin metal support 412 is clamped down by the annular retention plate 420. The larger the overlap length L3, the less free displacement the piezoelectric actuator assembly 428 has. If L3 is selected too long, motion of the piezoelectric actuator assembly 428 is impeded. If the overlap length L3 is selected too short, the piezoelectric actuator assembly 428 may not be secured properly, which could lead to rattling or displacement of the piezoelectric actuator assembly 428 within the bucket portion of the base 402. Flexibility of the piezoelectric actuator assembly 428 (e.g., the thin metal support 412 and piezoelectric actuator 410) is attributable to a combination of the overlap length L3, the thickness of the thin metal support 412, and material of the thin metal support 412.

Although a variety of arrangements are contemplated, the force-communicating structure 414 includes a thin piece of metal (e.g., stainless steel, nickel, or other suitable material) formed in a circular shape slightly smaller in diameter than the piezoelectric actuator assembly 428. In use, a PCBA (not shown) is suspended on top of the force-communicating structure 414. Pressure applied to the PCBA is transferred to the piezoelectric actuator assembly 428 by way of the dimple 416, which is formed in (e.g., punched into) the center of the high-hat force-communicating assembly 414. In effect, the dimple 416 allows for a re-focusing of a weight load distributed across a first, large surface area to a comparatively small surface area on the thin metal support 412.

The height of the dimple 416 (e.g., in the y-direction, as illustrated) is sufficiently high to allow for adequate up and down motion of a touch surface on top of the PCBA. A length L4 of the dimple 416 (e.g., in the x-direction) is critical in determining how much upward motion the piezoelectric actuator assembly 428 imparts onto the PCBA and top touch surface. When the length L4 is selected to be too large, motion of the piezoelectric actuator assembly 428 is diminished. If, in contrast, the length L4 is selected too small, weld strength of the dimple 416 to the piezoelectric actuator assembly 428 is weakened.

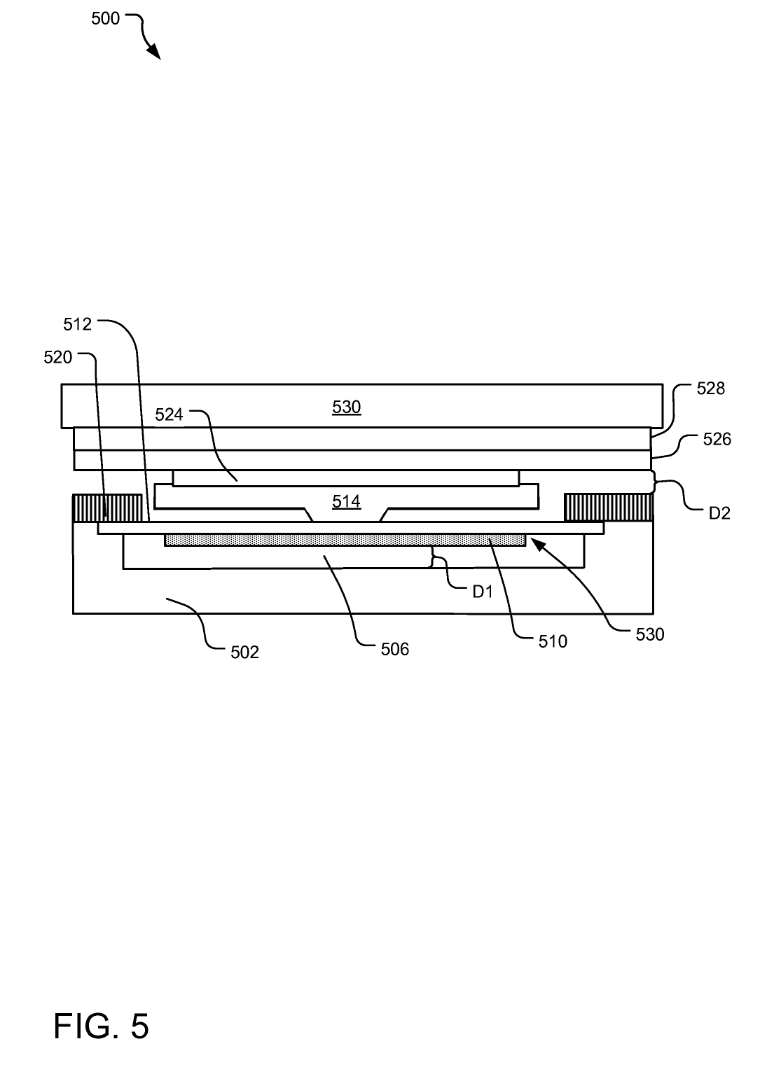

FIG. 5 illustrates a cross-sectional view of yet another example piezoelectric haptic feedback structure 500. The piezoelectric haptic feedback structure 500 includes a base 502 with a cavity 506. A piezoelectric actuator assembly 530 includes a piezoelectric actuator 510 and a thin metal support 512 and is suspended within the cavity 506. The cavity 506 has a depth Dl below the piezoelectric actuator assembly 520, as shown. A flat surface of the piezoelectric actuator assembly 520 is held flush with a surface of the base 502 by an annular retention plate 520 made of a flexible material, which acts as a two-way hinge to facilitate bidirectional movement of a central portion of the piezoelectric actuator assembly 530. A force-communicating structure 514 is welded to a top surface of the piezoelectric actuator assembly 530 and an adhesive layer 524 is formed atop of the force-communicating structure 514. The adhesive layer 524 allows for attachment of a PCBA 526 to the force-communicating structure 514.

A pressure-sensitive adhesive 528 is further formed on an upper surface of the PCBA 526, and a touch surface 530 (e.g., crystal silk, glass, bead-filled material on a substrate, etc.) is attached to the PCBA 526 by the pressure-sensitive adhesive 528. In one implementation, the depth Dl of the cavity 506 is selected to exceed a depth D2, representing a possible range of movement of the touch surface 530. This design detail prevents incidental contact between the piezoelectric actuator 510 and a base of the cavity 506.

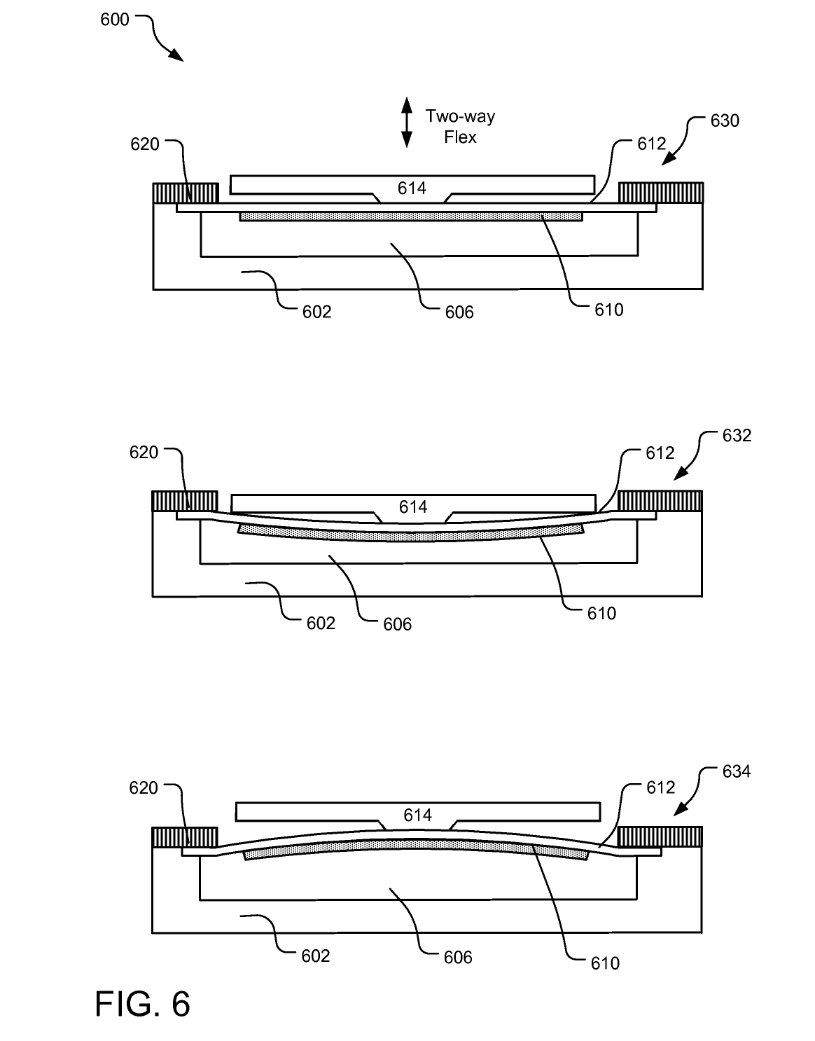

FIG. 6 illustrates cross-sectional views 630, 632, and 634 of another example piezoelectric haptic feedback structure 600 during different stages of use. The different cross-sectional views 630, 632, and 634 represent first, second, and third stages of the piezoelectric haptic feedback structure 600 employing piezoelectric actuators to detect pressure and provide haptic feedback.

The piezoelectric haptic feedback structure 600 includes a base 602 with a cavity 606 formed therein. A piezoelectric actuator assembly is suspended within the cavity 606 and includes a piezoelectric actuator 610 and a thin metal support 612. The piezoelectric actuator assembly is held in place by an annular retention plate 620 made from a flexible material that acts as a two-way circular hinge. The piezoelectric haptic feedback structure 600 further includes a force-communicating structure 614 attached to (e.g., welded to) a top surface of the thin metal support 612.

To better demonstrate operational principles, upper layers of the piezoelectric haptic feedback structure 600 (e.g., such the touch screen, PCBA, and pressure-sensitive adhesion layer of FIG. 5) are not illustrated in FIG. 6. However, it may be understood that these or other similar layer may be formed on top of the force-communicating structure 614 in each of the illustrated views 630, 632, and 634.

In view 630, no pressure is applied to the force-communicating structure 614. The piezoelectric actuator assembly is not strained and as such does not output a voltage. In the view 632, a force such as that generated by a user's finger pressing on a touchpad causes deflection of the thin metal support 612 and thus strain on the piezoelectric actuator 610 which results in an output voltage that is detectable by a pressure sensing and haptic feedback module (not shown). As the voltage output by the piezoelectric actuator 610 changes with an amount of pressure applied, the piezoelectric actuator 610 is configured to detect not just presence or absence of pressure (e.g., a respective one of a plurality of levels of pressure). Other techniques to detect pressure are also contemplated, such as changes in capacitance, changes in detect contact size, strain gauges, piezo-resistive elements, etc.

The piezoelectric haptic feedback structure 600 is also usable to provide a haptic feedback as shown in the view 634. In view 634, the piezoelectric actuator 610 detects an amount of pressure applied to the force-communicating structure 614. If the detected pressure is over a threshold, the pressure sending and haptic feedback module energizes the piezoelectric actuator 610. This causes the piezoelectric actuator 610 to pull upward against the force-communicating structure 614 and thus deflect outward back toward an object applying the pressure, thereby providing a haptic response.

In this way, the piezoelectric actuator assembly is leveraged to provide both pressure sensing and haptic feedback. Other examples are also contemplated. For instance, pressure may be sensed by a pressure sensor that is not the piezoelectric actuator 610 and then the piezoelectric actuator 610 may be used to provide haptic feedback. In another implementation, a first piezoelectric actuator is used to detect pressure and another piezoelectric actuator is used to provide haptic feedback. In still another implementation, the piezoelectric actuator assembly provides haptic feedback but does not detect pressure.

FIG. 7A illustrates a cross-sectional view of another example piezoelectric haptic feedback structure 700. The piezoelectric haptic feedback structure 700 includes a base 702 with a v-grooved support ring 704 attached thereto. A piezoelectric actuator assembly 728 includes a piezoelectric actuator 710 and a thin metal support 712 and has a perimeter resting within the v-grooved support ring 704 (e.g., v-grooved bezel), effectively suspending the piezoelectric actuator 710 above the base 702. A number of alignment stoppers (e.g., an alignment stopper 716) secure the v-grooved support ring 704 into a position on the base 702. The v-grooved support ring 704 acts as a two-way hinge permitting bidirectional movement of a central portion of the piezoelectric actuator assembly 728 both toward and away from the base 702. Although not illustrated, the piezoelectric haptic feedback structure 700 may include a number of additional layers and components the same or similar to those described with respect to any of FIGS. 1-6.

FIG. 7B illustrates a top-down view of the example piezoelectric haptic feedback structure 700 of FIG. 7A (e.g., FIG. 7A is a cross sectional view of FIG. 7B across an axis A). The piezoelectric actuator 710 is shown in dotted lines to indicate that it is attached to an underside (not shown) of the thin metal support 712. In addition to the alignment stopper 716, FIG. 7B additionally illustrates alignment stoppers 720, 722, and 724. These alignment stoppers hold the v-grooved support ring 704 in place relative to the base 702.

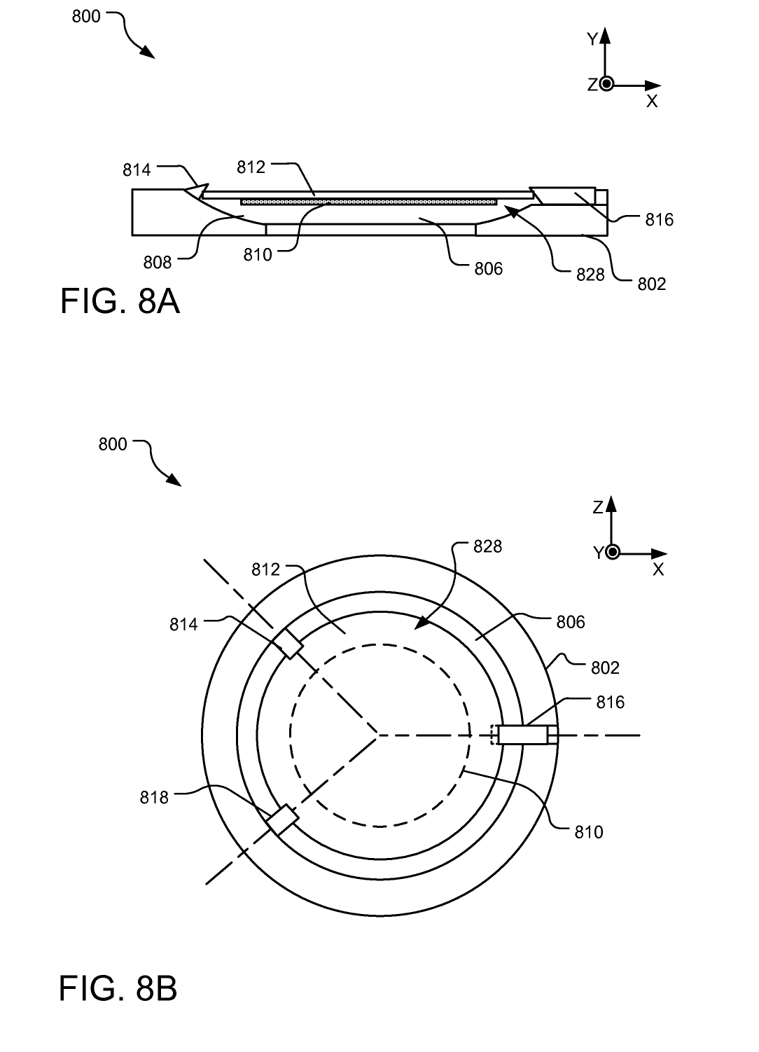

As shown in FIG. 7B, the v-grooved support ring 704 is an open ring with two handles 730 and 732 formed on each end and a notch or opening 718 between the handles 730 and 732. The handles 730, 732, and support ring 704 have a degree of elasticity, length, and thickness sufficient to allow for slight manipulation of a perimeter shape of the support ring 704 when the handles 730 and 732 are pushed together or pulled apart. For example, when the handles 730 and 732 are pulled apart from one another, the v-grooved support ring 704 expands slightly, allowing for insertion of the piezoelectric actuator assembly 728 during initial setup. Likewise, the handles 730 and 732 can be forced inward (e.g., toward one another) by the alignment stoppers 720 and 722 to regulate how tight the support ring 704 hugs the thin metal support 712. FIG. 8A illustrates a cross-sectional view of another example piezoelectric haptic feedback structure 800 suitable for implementation in a haptic feedback touchpad. The piezoelectric haptic feedback structure 800 includes a base 802 including a spherical cavity 806 with a sloping or curved sidewall 808 (e.g., a spherical bowl support surface). A piezoelectric actuator assembly 828 includes a piezoelectric actuator 810 and a thin metal support 812 has a perimeter resting within the spherical cavity 806 and against the curved sidewall 808. One or more positioning stubs (e.g., a positioning stub 814) extend outward from an edge of the curved sidewall 808 and over a portion of the spherical cavity 806 to hold the piezoelectric actuator in a set position. A sliding clamp 816 allows for initial insertion and positioning of the piezoelectric actuator assembly 828 and aids in securing the piezoelectric actuator assembly 828 within the spherical cavity 806. If the positioning stub(s) (e.g., the positioning stub 814) and the sliding clamp 816 are made of rigid material, the positioning stub(s) and sliding clamp 816 act as a circular hinge. This configuration permits a center portion of the piezoelectric actuator assembly 828 to flex down toward the base of the spherical cavity 806 as well as upward, away from the base of the spherical cavity 806. Due to the design of the sliding clamp 816, the piezoelectric actuator assembly 828 may, in some implementations, experience a greater range of motion when flexing downward from the illustrated stationary position and toward the based of the spherical cavity 806 than when flexing upward from the illustrated stationary position and away from the base of the spherical cavity 806.

FIG. 8B illustrates a top-down view of the example piezoelectric haptic feedback structure 800 of FIG. 8A. The piezoelectric actuator 810 is shown in dotted lines to indicate that attachment to an underside (not shown) of the thin metal support 812. FIG. 8B illustrates two positioning stubs 814 and 818. Other implementations may include one or more than two positioning stubs. If the cavity 806 is generally spherical, the positioning stubs 814, 818, and sliding clamp 816 can maintain contact with the rim of the thin metal support 812 even where there is a lateral alignment offset.

During assembly of the piezoelectric haptic feedback structure 800, the sliding clamp 816 is positioned in a release position (not shown) to allow for initial positioning of the piezoelectric actuator assembly 828 within the spherical cavity 806. Once the piezoelectric actuator assembly 828 is positioned, the sliding clamp 816 is secured (as shown) and the sliding clamp 816 and positioning stubs 814, 818 together hold the piezoelectric actuator assembly 828 within the spherical cavity 806 to maintain an edge-only contact between the piezoelectric actuator assembly 828 and the supporting surface of the spherical cavity 806. This may create an offset of the piezoelectric actuator assembly 828 from the center position. However, this off-center position can be tolerated since the sidewall of the cavity 806 supporting the piezoelectric actuator assembly 828 is spherical. The sliding clamp 816 can be affixed in the illustrated position in a variety of suitable ways, such as by adhesive, screw or heat stake.

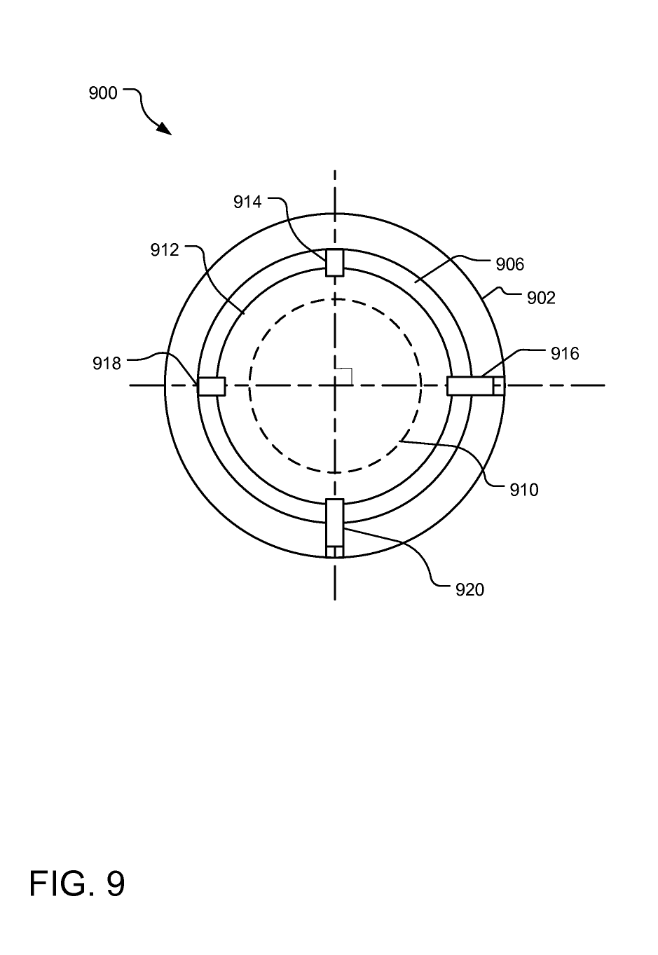

FIG. 9 illustrates a top-top view of another example piezoelectric haptic feedback structure 900. The piezoelectric haptic feedback structure 900 includes many elements that are the same or similar to the piezoelectric haptic feedback structure of FIGS. 8A-8B, such as a base 902 with a spherical cavity 906 including a sloping or curved sidewall (not shown) for receiving and suspending a piezoelectric actuator assembly including a piezoelectric actuator 910 and a thin metal support 912. In contrast to the implementations of FIGS. 8A-8B, the piezoelectric actuator of the piezoelectric haptic feedback structure 900 is held securely within a spherical cavity 906 by two sliding clamps 916 and 920 and two positioning stubs 914 and 918, each separated from an adjacent stub and sliding clamp by approximately 90 degrees. Other implementations may include greater than two sliding clamps.

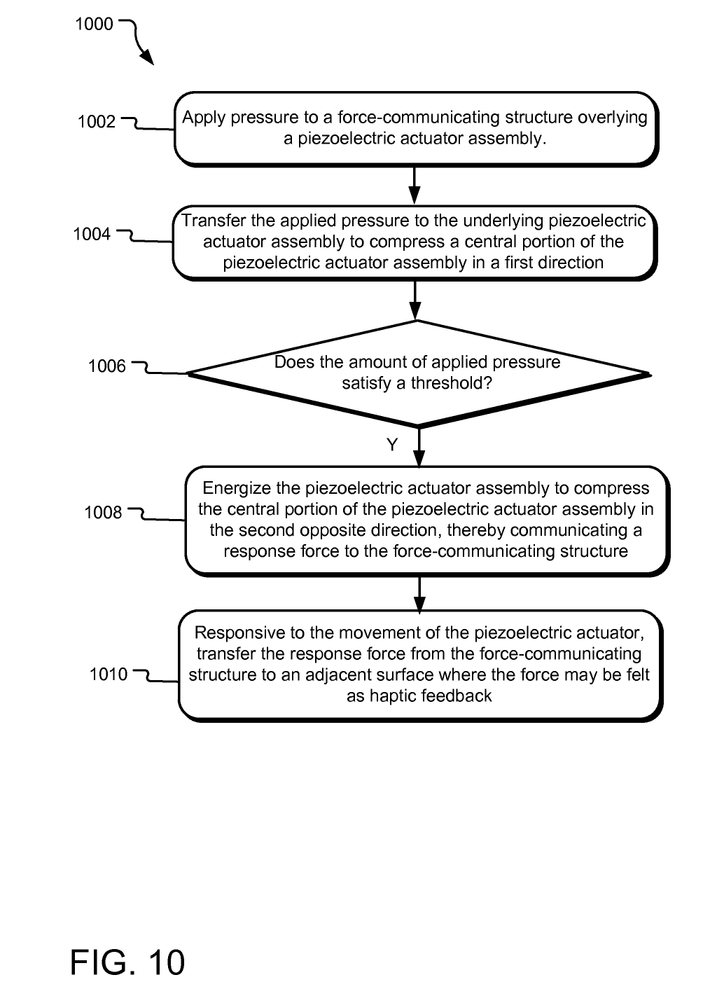

FIG. 10 illustrates example operations 1000 for using a piezoelectric haptic feedback structure. A pressure application operation 1002 applies pressure to a force-communicating structure of the piezoelectric haptic feedback structure overlying a piezoelectric actuator assembly. In one implementation, the piezoelectric actuator assembly includes a piezoelectric actuator and a thin metal support. The thin metal support is suspended within a cavity formed in a supporting base. For example, the piezoelectric actuator may be secured adjacent to the supporting base at a plurality of points jointly operating as a perimeter hinge to facilitate movement of the piezoelectric actuator assembly toward a base of the cavity and/or in a direction away from a base of the cavity.

A force-communicating operation 1004 transfers the pressure applied to the force-communicating structure to the underlying piezoelectric actuator assembly to compress a central portion of a piezoelectric actuator of the piezoelectric actuator assembly. According to one implementation, the force-communicating structure receives the pressure at a wide neck portion and transfers the pressure to the piezoelectric actuator assembly through a narrow base portion. For example, the narrow base portion of the force-communicating assembly may include a protrusion (e.g., dimple) that contacts a center of the piezoelectric actuator assembly.

A determination operation 1006 determines whether the amount of applied pressure satisfies a threshold. If the amount of applied pressure does satisfy a threshold, an energizing operation 1008 energies the piezoelectric actuator assembly to compress the central portion of the piezoelectric actuator assembly in the second opposite direction, thereby communicating a response force.

Responsive to the compression of the piezoelectric actuator assembly, a force transferring operation 1010 transfers the response force from the force-communicating structure to an adjacent surface, where the force may be felt as haptic feedback by a user. For example, a user may feel a slight pop, upward tap, vibration, or other sensation via the adjacent surface.

An example input device includes a supporting base that defines a cavity and a piezoelectric actuator assembly at least partially suspended within the cavity. A perimeter hinge secures a perimeter portion of the piezoelectric actuator assembly while permitting movement of a central portion of the piezoelectric actuator assembly, and the input device also includes a force-communicator configured to communicate haptic feedback based at least on movement of the central portion of the piezoelectric actuator assembly.

In another example implementation of any preceding input device, the piezoelectric actuator assembly includes a portion that rests within an upper tier of the cavity and another portion suspended within a lower tier of the cavity with a smaller diameter than the upper tier of the cavity.

In another example implementation of any preceding input device, the perimeter hinge is a two-way hinge.

In another example implementation of any preceding input device, the two-way hinge is a flexible annular retention plate that clamps a thin metal support of the piezoelectric actuator assembly against the supporting base.

In still another example implementation of any preceding input device, the perimeter hinge is a v-grooved support ring.

In another example implementation of any preceding input device, the perimeter hinge is formed by a spherical support surface within the cavity and at least one clamp that secures the piezoelectric actuator assembly against the spherical support surface.

In another example implementation of any preceding input device, the force-communicator contacts a surface of the piezoelectric actuator assembly opposite the cavity.

In another example implementation of any preceding input device, the force-communicator transfers pressure applied by an object to the piezoelectric actuator assembly to move the central portion of the piezoelectric actuator assembly toward a base of the cavity.

An example haptic feedback device comprises a supporting base defining a cavity sized and shaped to receive a portion of a piezoelectric actuator assembly, and a perimeter hinge securing a perimeter portion of the piezoelectric actuator assembly against the supporting base while permitting movement of a central portion of the piezoelectric actuator assembly within the cavity. A force-communicator of the haptic feedback device is configured to communicate haptic feedback based at least on movement of the central portion of the piezoelectric actuator assembly.

In another example haptic feedback device of any preceding haptic feedback device, the piezoelectric actuator assembly includes a portion that rests within an upper tier of the cavity and another portion suspended within a lower tier of the cavity with a smaller diameter than the upper tier of the cavity.

In still another example haptic feedback device of any preceding haptic feedback device, the perimeter hinge is a two-way hinge. In yet another example haptic feedback device of any preceding haptic feedback device, the two-way hinge is a flexible annular retention plate that clamps a thin metal support of the piezoelectric actuator assembly against the supporting base.

In another example haptic feedback device of any preceding haptic feedback device, the perimeter hinge is v-grooved support ring. In another example haptic feedback device of any preceding haptic feedback device, the perimeter hinge is formed by a spherical support surface within the cavity and at least one clamp that secures the piezoelectric actuator assembly against the spherical support surface.

In still another example haptic feedback device of any preceding haptic feedback device, the force-communicator includes a wide neck portion and a narrow base portion and is further configured to receive pressure at the wide neck portion and transfer the pressure to the piezoelectric actuator assembly through the narrow base portion.

In still another example haptic feedback device of any preceding haptic feedback device, the force-communicator transfers pressure applied by an object to the piezoelectric actuator assembly to move the central portion of the piezoelectric actuator assembly toward a base of the cavity.

An example method for communicating haptic feedback comprises moving a central portion of a piezoelectric actuator assembly to communicate a force, where the piezoelectric actuator is secured at a plurality of perimeter points and at least partially suspended within a cavity defined by a supporting base. The method further comprises communicating haptic feedback via a force-communicator based on movement of the piezoelectric actuator assembly within the cavity.

In another method of any preceding method, moving the central portion of the piezoelectric actuator assembly further comprises applying pressure to the force-communicator to move the central portion of the piezoelectric actuator assembly toward a base of the cavity and receiving the haptic feedback at the force-communicator responsive to the application of pressure.

In another method of any preceding method, the method further comprises receiving the applied pressure at a wide neck portion of the force-communicator; and transferring the pressure to the piezoelectric actuator assembly through a narrow base portion of the force-communicator.

In still another method of any preceding method, the circular hinge is a flexible annular retention plate that clamps a thin metal support of the piezoelectric actuator assembly against the supporting base.

An example system for communicating haptic feedback comprises a means for moving a central portion of a piezoelectric actuator assembly to communicate a force, where the piezoelectric actuator is secured at a plurality of perimeter points and at least partially suspended within a cavity defined by a supporting base. The system further comprises a means to communicate haptic feedback based on movement of the piezoelectric actuator assembly within the cavity.

The implementations of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, adding and omitting as desired, unless explicitly claimed otherwise or a specific order is inherently necessitated by the claim language.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different embodiments may be combined in yet another implementation without departing from the recited claims.

What is claimed is:

1. An input device comprising:
a supporting base defining a cavity;
a piezoelectric actuator assembly at least partially suspended within the cavity;
a perimeter hinge securing a perimeter portion of the piezoelectric actuator assembly while permitting movement of a central portion of the piezoelectric actuator assembly; and
a force-communicator configured to communicate haptic feedback based at least on movement of the central portion of the piezoelectric actuator assembly.

2. The input device of claim 1, wherein the piezoelectric actuator assembly includes a portion that rests within an upper tier of the cavity and another portion suspended within a lower tier of the cavity with a smaller diameter than the upper tier of the cavity.

3. The input device of claim 1, wherein the perimeter hinge is a two-way hinge.

4. The input device of claim 3, wherein the two-way hinge is a flexible annular retention plate that clamps a thin metal support of the piezoelectric actuator assembly against the supporting base.

5. The input device of claim 3, wherein the perimeter hinge is a v-grooved support ring.

6. The input device of claim 1, wherein the perimeter hinge is formed by a spherical support surface within the cavity and at least one clamp that secures the piezoelectric actuator assembly against the spherical support surface.

7. The input device of claim 1, wherein the force-communicator contacts a surface of the piezoelectric actuator assembly opposite the cavity.

8. The input device of claim 1, wherein the force-communicator transfers pressure applied by an object to the piezoelectric actuator assembly to move the central portion of the piezoelectric actuator assembly toward a base of the cavity.

9. A haptic feedback device comprising:
a supporting base defining a cavity sized and shaped to receive a portion of a piezoelectric actuator assembly;
a perimeter hinge securing a perimeter portion of the piezoelectric actuator assembly against the supporting base while permitting movement of a central portion of the piezoelectric actuator assembly within the cavity; and
a force-communicator configured to communicate haptic feedback based at least on movement of the central portion of the piezoelectric actuator assembly.

10. The haptic feedback device of claim 9, wherein the piezoelectric actuator assembly includes a portion that rests within an upper tier of the cavity and another portion suspended within a lower tier of the cavity with a smaller diameter than the upper tier of the cavity.

11. The haptic feedback device of claim 9, wherein the perimeter hinge is a two-way hinge.

12. The haptic feedback device of claim 11, wherein the two-way hinge is a flexible annular retention plate that clamps a thin metal support of the piezoelectric actuator assembly against the supporting base.

13. The haptic feedback device of claim 11, wherein the perimeter hinge is v-grooved support ring.

14. The haptic feedback device of claim 9, wherein the perimeter hinge is formed by a spherical support surface within the cavity and at least one clamp that secures the piezoelectric actuator assembly against the spherical support surface.

15. The haptic feedback device of claim 9, wherein the force-communicator includes a wide neck portion and a narrow base portion and is further configured to receive pressure at the wide neck portion and transfer the pressure to the piezoelectric actuator assembly through the narrow base portion.

16. The haptic feedback device of claim 9, wherein the force-communicator transfers pressure applied by an object to the piezoelectric actuator assembly to move the central portion of the piezoelectric actuator assembly toward a base of the cavity.

17. A method comprising:
moving a central portion of a piezoelectric actuator assembly to communicate a force, the piezoelectric actuator secured at a plurality of perimeter points and at least partially suspended within a cavity defined by a supporting base; and
communicating haptic feedback via a force-communicator based on movement of the piezoelectric actuator assembly within the cavity.

18. The method of claim 17, wherein moving the central portion of the piezoelectric actuator assembly further comprises:
applying pressure to the force-communicator to move the central portion of the piezoelectric actuator assembly toward a base of the cavity; and
receiving the haptic feedback at the force-communicator responsive to the application of pressure.

19. The method of claim 19, further comprising:
receiving the applied pressure at a wide neck portion of the force-communicator; and
transferring the pressure to the piezoelectric actuator assembly through a narrow base portion of the force-communicator.

20. The method of claim 17, wherein the circular hinge is a flexible annular retention plate that clamps a thin metal support of the piezoelectric actuator assembly against the supporting base.
